(19) United States
(12) Patent Application Publication
(10) Pub. No.: US 2004/0223441 A1
(43) Pub. Date: Nov. 11, 2004

(54) Information recording apparatus, information reproducing apparatus, information recording method, information reproducing method and information recording medium

(75) Inventor: Kazuo Kuroda, Saitama (JP)

Correspondence Address: NIXON & VANDERHYE, PC, 1100 N GLEBE ROAD, 8TH FLOOR, ARLINGTON, VA, 22201-4714, US

(73) Assignee: Pioneer Corporation, Tokyo (JP)

(21) Appl. No.: 10/822,147

(22) Filed: Apr. 12, 2004

(30) Foreign Application Priority Data
Apr. 10, 2003 (JP) 2003-106278

(51) Int. Cl. G11B 7/00

(52) U.S. Cl. 369/103

(57) ABSTRACT

The information recording apparatus generates the signal light and the reference light from one laser light, and irradiates the signal light and the reference light on the recording medium to record the information by utilizing the interference fringes. Namely, the information recording apparatus executes a so-called hologram recording. Though the signal light is generated by spatial-modulating the laser light by the recording information, the one-dimensional spatial modulation is performed in the present invention. By performing the one-dimensional spatial modulation, recording the information is possible even if the recording medium is moving in a direction perpendicular or nearly perpendicular to the direction of the spatial modulation. Thereby, even if the irradiation position of the signal light and the reference light is moving relatively to the recording medium, e.g., while a disc-type recording medium is rotating, the hologram recording is possible. Thus, the random access performance to the recorded information can be improved and a configuration of the apparatus can be simplified.

### BACKGROUND OF THE INVENTION

1. Field of the Invention

The present invention relates to a recording and reproducing method of information by utilizing a hologram.

2. Description of Related Art

There is known a method by utilizing a hologram, as a method for recording and reproducing information on an optical recording medium with high-density. In hologram recording, a reference light and a signal light modulated by a pattern corresponding to a recording signal are generated based on a laser light emitted from a laser light source, and the reference light and the signal light are irradiated on a recording medium. The recording medium is formed by sealing a hologram medium, and interference fringes formed by the reference light and the signal light are recorded on the recording medium. In reproducing the information, only the reference light is irradiated on the recording medium, and a diffracted light which is generated by the recorded interference fringes is received by a photodetector and the like to obtain the recorded information. A recording and reproducing apparatus utilizing the hologram is disclosed in Japanese Patent Applications Laid-open under No. 2002-216359 and No. 6-333233.

As seen in the above-mentioned Japanese Patent Applications, the known hologram recording method records the information as a two-dimensional image on the recording medium in a relatively stationary state, by utilizing a two-dimensional spatial modulating unit. Therefore, when the recording lights (i.e., the signal light and the reference light) are irradiated, the recording medium has to be stationary relatively to a spatial modulating unit. If the side of a recording optical system such as a pickup is fixed, the recording medium is driven so that a recording position on the recording medium is stopped at an irradiating position of the recording light, and the recording is executed by irradiating the recording light. Then, the recording medium is again driven so that a next recording position on the recording medium is stopped at the irradiating position of the recording light to execute the recording. This operation is repeated. On the other hand, if the side of the recording medium is fixed, the recording is executed at the recording position of the recording medium by repeatedly moving and stopping the recording optical system.

However, when driving and stopping of the recording medium have to be repeated during recording and reproducing, a so-called random access becomes uneasy. In a case of the recording medium such as a disc, since inertia of the disc is large, it is difficult to execute the driving and the stopping of the disc in a short time. In addition, since a rotation speed has to be small in order to frequently stop the disc, a speed at the time of the random access cannot be increased.

On the other hand, in the above-mentioned Japanese Patent Application Laid-open under No. 2002-216359, there is proposed a method, in which the recording light and the recording medium are made in a relatively stationary state by moving the pickup during the rotation of the disc. However, controlling both the recording optical system and the disc drive is complicated, which brings about a complicated and large-scale apparatus. Further, when moving the optical system such as the pickup, in addition to the control of the disc in the focus and the tracking directions, the movement control in a tangential direction of the disc is necessary, and the pickup has to be controlled in three-axes directions. Thereby, the axis of the pickup is inclined, and a deficiency, e.g., the recording light cannot be appropriately irradiated on the disc, may happen.

### SUMMARY OF THE INVENTION

The present invention has been achieved in order to solve the above problems. It is an object of this invention to provide a hologram recording method capable of improving random access performance.

First, a basic principle of a hologram recording and reproducing system according to the present invention will be explained. The hologram recording and reproducing system of the present invention is characterized in that one-dimensional spatial modulation is applied to a signal light, and the recording and reproducing is executed with a recording medium such as an optical disc being moved. In the known hologram recording which was described above, the signal light was modulated by utilizing the two-dimensional spatial modulating unit, and the recording was executed with the recording medium and the recording light being relatively stationary to each other. On the other hand, in the hologram recording and reproducing system of the present invention, the signal light is modulated by the one-dimensional spatial modulating unit. Though the recording medium such as the optical disc is moved, the irradiating position of the recording light, i.e., an optical system is fixed. Namely, the irradiating position of the recording light on the optical disc relatively moves on the disc. The one-dimensional spatial modulation is executed in a direction perpendicular or nearly perpendicular to a relative moving direction of the recording light on the recording medium. Thereby, the recording and reproducing with the recording medium such as the optical disc being moved is possible, and a random access performance is improved.

Specifically, the information recording apparatus in the preferred embodiment of the present invention includes: a laser light source; a dividing unit which divides a laser light emitted from the laser light source in two laser lights; a one-dimensional spatial modulating unit which applies one-dimensional spatial modulation to one of the two divided laser lights based on recording information; a recording optical system which irradiates the spatial-modulated laser light to a recording medium as a signal light and irradiates the other one of the two divided laser lights to the recording medium as a reference light, thereby to record the recording information on the recording medium; and a moving unit which moves the recording medium with respect to the recording optical system such that an irradiation position of the signal light and the reference light relatively moves on the recording medium, wherein the recording optical system records the recording information while the moving unit is moving the recording medium.

The above-mentioned information recording apparatus generates the signal light and the reference light from one laser light, and irradiates the signal light and the reference light on the recording medium to record the information by utilizing the interference fringes. Namely, the information recording apparatus executes a so-called hologram recording. Though the signal light is generated by spatial-modulating the laser light by the recording information, the one-dimensional spatial modulation is performed in the present invention. By performing the one-dimensional spatial modulation, recording the information is possible even if the recording medium is moving in a direction perpendicular or nearly perpendicular to the direction of the spatial modulation. Thereby, even in a state that the irradiation position of the signal light and the reference light is moving relatively to the recording medium, e.g., while a disc-type recording medium is rotating, the hologram recording is possible. Thus, the random access performance to the recorded information can be improved and a configuration of the apparatus can be simplified.

In a preferred embodiment, the one-dimensional spatial modulating unit may include a grating configuration having a plurality of gratings, and the one-dimensional spatial modulating unit may be positioned such that an alignment direction of irradiation images produced by the plurality of gratings is perpendicular to the moving direction of the recording medium by the moving unit. Also, when a disc is utilized as the recording medium, the one-dimensional spatial modulating unit may be positioned such that the alignment direction of the irradiation images produced by the plurality of gratings corresponds to a radial direction of the disc.

In another preferred embodiment, the one-dimensional spatial modulating unit may include the grating configuration having a plurality of gratings, and the one-dimensional spatial modulating unit may be positioned such that an alignment direction of irradiation images produced by the plurality of gratings has a predetermined angle with respect to a direction perpendicular to the moving direction of the recording medium by the moving unit. Also, when a disc is utilized as the recording medium, the one-dimensional spatial modulating unit may be positioned such that the alignment direction of the irradiation images produced by the plurality of gratings has a predetermined angle with respect to the radial direction of the disc. Thereby, when a damage such as a scratch is made in the radial direction of the disc, the reproduction of the recording information is ensured.

Moreover, the above-mentioned information recording apparatus may include a unit which controls a light quantity of the laser light from the laser light source based on the recording information. By controlling ON/OFF switching of the laser emission based on the recording information, it becomes possible to modulate the information to the moving direction of the recording medium and record the information. Therefore, in addition to modulating the recording information in a direction perpendicular to the moving direction of the recording medium by one-dimensional spatial modulation, modulating the recording information and recording the information in the moving direction of the recording medium can be performed, and the improvement of information recording density is possible.

Also, the reproducing unit may be provided to the recording apparatus, which irradiates only the reference light on the recording medium and reproduces the recording information based on the reflected light from the recording medium. By reproducing the above-mentioned recording information while the moving unit is moving the recording medium, the information recording and reproducing apparatus can be achieved.

The information recording apparatus in another embodiment of the present invention includes: a laser light source; a one-dimensional spatial modulating unit which applies one-dimensional spatial modulation to a laser light emitted from the laser light source based on recording information; a recording optical system which irradiates a light mainly including luminance component of the spatial-modulated laser light to a recording medium as a reference light and irradiates a light mainly including phase component of the spatial-modulated laser light to the recording medium as a signal light, thereby to record the recording information on the recording medium; and a moving unit which moves the recording medium with respect to the recording optical system such that an irradiation position of the signal light and the reference light relatively moves on the recording medium, wherein the recording optical system records the recording information while the moving unit is moving the recording medium.

The above-mentioned information recording apparatus applies the one-dimensional spatial modulation to the laser light. The information recording apparatus irradiates a light mainly including the luminance component, e.g., a 0th-order light of the spatial-modulated laser light, as the reference light, and also irradiates a light mainly including the phase component, e.g., 1st-order or higher order light, as the signal light on the recording medium to record the information. By performing the one-dimensional spatial modulation, the information can be recorded even if the recording medium is moving in a direction perpendicular or nearly perpendicular to the direction of the spatial modulation. Thereby, in a state that the irradiation position of the signal light and the reference light is moving relatively to the recording medium, e.g., while the disc-type recording medium is rotating, the hologram recording is possible. Therefore, the random access performance of the recording information can be improved, and the configuration of the apparatus can be simplified.

In a preferred embodiment, the one-dimensional spatial modulating unit may include a grating configuration having a plurality of gratings, and the one-dimensional spatial modulating unit may be positioned such that the alignment direction of the plurality of gratings is perpendicular to the moving direction of the recording medium by the moving unit. Also, when a disc is utilized as the recording medium, the one-dimensional spatial modulating unit may be positioned such that the alignment direction of the plurality of gratings corresponds to the radial direction of the disc.

In another preferred embodiment, the one-dimensional spatial modulating unit may include the grating configuration having a plurality of gratings, and the one-dimensional spatial modulating unit may be positioned such that the alignment direction of the plurality of gratings has the predetermined angle with respect to the moving direction of the recording medium by the moving unit. When a disc is utilized as the recording medium, the one-dimensional spatial modulating unit may be positioned such that the alignment direction of the plurality of gratings has the predetermined angle with respect to the radial direction of the disc. Thereby, when the scratch or the damage is made in the radial direction of the disc, reproducing the recording information is ensured.

Moreover, the above-mentioned information recording apparatus may include a unit which controls the light quantity of the laser light from the laser light source based on the recording information. By controlling the ON/OFF switching of the laser emission based on the recording information, it is possible to modulate the information in the moving direction of the recording medium to record information.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIG. 1 is a block diagram showing a configuration of hologram disc recording and reproducing apparatus according to the embodiment of the present invention.

FIG. 2 schematically shows a state in which a signal light is irradiated on a disc by the hologram disc recording and reproducing apparatus shown in FIG. 1.

FIG. 3 schematically shows an example of Fourier image formed on a disc.

FIG. 4 shows a configuration example of a light-receiving element shown in FIG. 1.

FIGS. 5A and 5B show examples of hologram marks formed according to the modulation.

FIGS. 6A and 6B show examples for explaining a method of recording by shifting an axis direction of Fourier image from a disc radial direction.

FIG. 7 schematically shows a state in which a signal light is irradiated on a disc by a hologram disc recording and reproducing apparatus which utilizes a cylindrical lens.

FIG. 8 is a block diagram showing a configuration example of a recording and reproducing apparatus for a card-type recording medium.

FIG. 9 is a block diagram showing a configuration example of a recording and reproducing apparatus in a case of adopting a recording method without dividing a laser light.

FIG. 10 is a diagram showing a state of an optical beam near a recording medium of the recording and reproducing apparatus shown in FIG. 9.

### DETAILED DESCRIPTION OF THE PREFERRED EMBODIMENTS

The preferred embodiments of the present invention will now be described below with reference to the attached drawings.

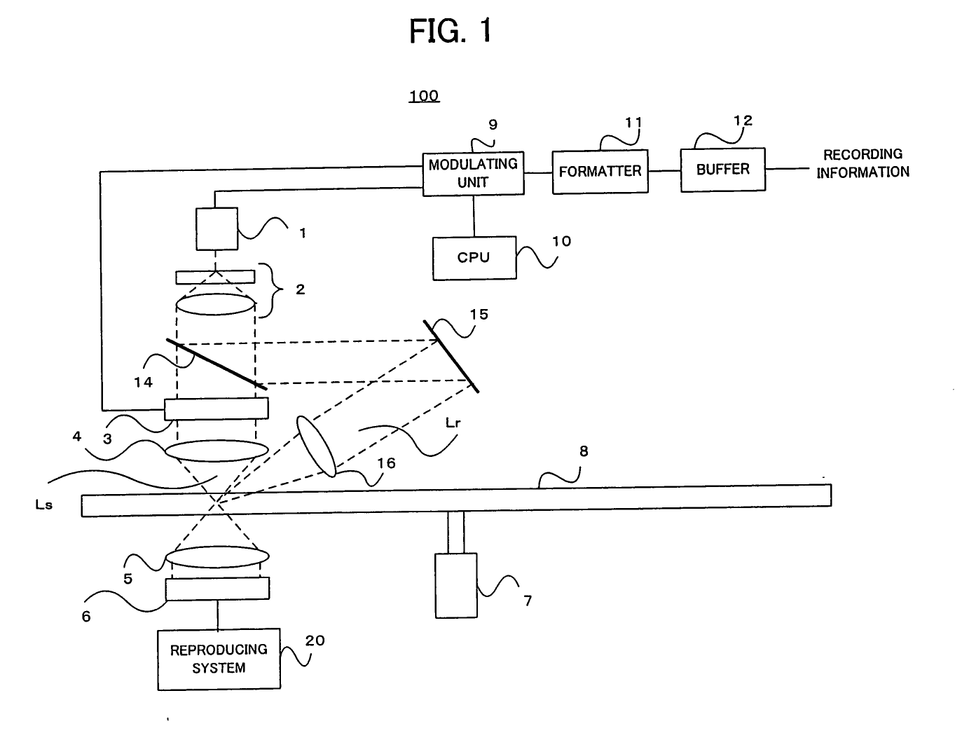

FIG. 1 shows a configuration of the hologram disc recording and reproducing apparatus (hereafter, it is also simply called “recording and reproducing apparatus”) in the embodiment of the present invention. As shown in FIG. 1, a recording and reproducing apparatus 100 records information on a hologram disc (hereafter, it is simply called “disc”) 8 and reproduces the information therefrom. For example, the disc 8 may be formed by injecting a hologram medium, such as a photopolymer, between two glass substrates, and the same disc as is utilized for the hologram recording in the above-mentioned known art can be utilized. The disc 8 is rotated by a spindle motor 7. It is noted that the rotation of the spindle motor 7 is controlled by a spindle servo method which is executed during the recording and reproducing of the ordinary optical disc.

The recording information which is inputted from outside is temporarily retained in a buffer 12 once, and is transmitted to a formatter 11. The formatter 11 executes, to the recording information, a necessary process such as an addition of ECC (Error Correction Code), and generates data corresponding to a predetermined recording format to supply the data to the modulating unit 9. The modulating unit 9 executes two kinds of modulations. One is the modulation of the signal light by the one-dimensional spatial modulating unit 3 which will be explained later, and the other is the modulation of a laser light emitted from a laser light source 1. The modulations will be explained later.

The optical system, which generates the recording lights (the signal light and the reference light) and irradiates the recording lights on the disc 8, includes the laser light source 1, an expander 2, a one-dimensional spatial modulating unit 3, a Fourier transforming lens 4, and an inverse Fourier transforming lens 5, a light-receiving element 6, a half mirror 14, a reflection mirror 15 and a condensing lens 16. The disc 8 is disposed between the Fourier transforming lens 4 and the inverse Fourier transforming lens 5.

A diameter of the laser light emitted from the laser light source 1 is increased by the expander 2, and the laser light is divided in two lights, i.e., the signal light and the reference light by the half mirror 14. The laser light passed the half mirror 14 is modulated according to the pattern obtained from the modulating unit 9 by passing the one-dimensional spatial modulating unit 3, and is incident on the Fourier transforming lens 4 to be irradiated, as a signal light Ls, on the disc 8 by passing the Fourier transforming lens 4.

The other laser light divided by the half mirror 14 is reflected by the reflection mirror 15, and is irradiated, as a reference light Lr, on a recording surface of the disc 8 via the condensing lens. 16. On the recording surface of the disc 8, the signal light Ls and the reference light Lr are simultaneously irradiated to the identical position of the disc 8. Thereby, the signal light Ls and the reference light Lr interfere with each other on the disc 8, on which the interference fringes are generated, and the interference fringes are recorded in the hologram medium inside the disc 8 as Fourier image.

On the other hand, during reproducing the information, the signal light Ls is cut off in order not to be irradiated on the disc 8, and only the identical reference light Lr utilized during recording is irradiated on the disc 8. The irradiated reference light Lr is diffracted by the interference fringes recorded on the disc 8, and a diffracted light is generated. The diffracted light is irradiated on the light-receiving element 6 via the inverse Fourier transforming lens 5, and a reproducing signal is obtained. The reproducing signal is supplied to a reproducing system 20.

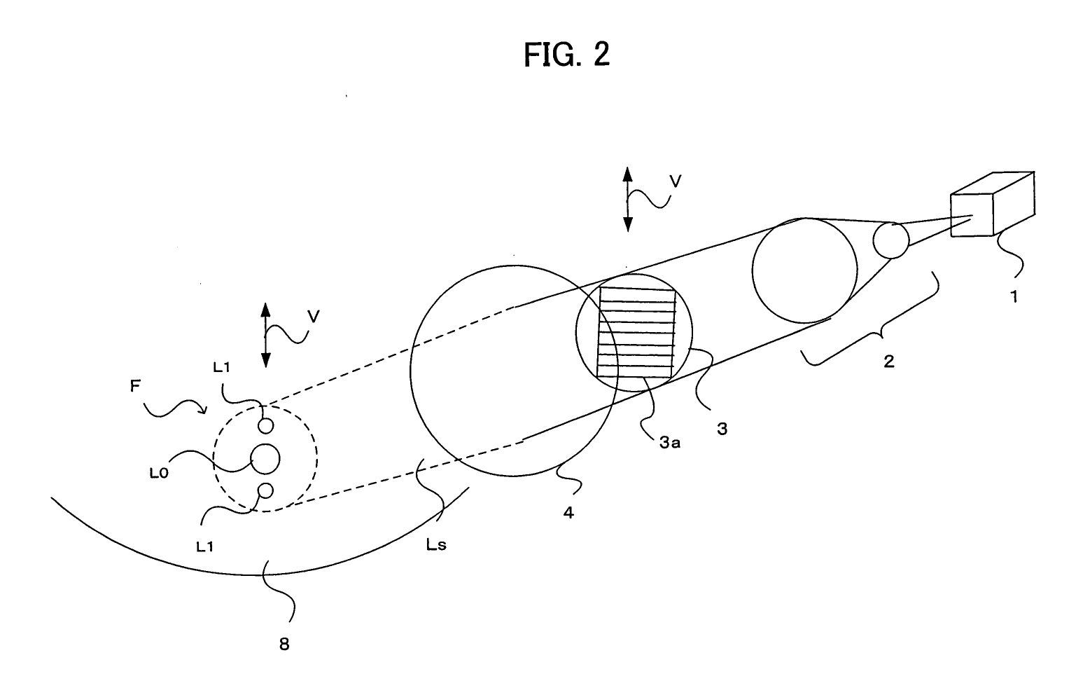

FIG. 2 schematically shows a state that the signal light Ls is irradiated on the disc by the recording and reproducing apparatus 100 shown in FIG. 1. The laser light emitted from the laser light source 1 is enlarged by the expander 2, and is incident on the one-dimensional spatial modulating unit 3. The one-dimensional spatial modulating unit 3 has a grating configuration 3a, as shown in FIG. 2. In the example in FIG. 2, the grating configuration 3a which is continuous in the vertical direction (in the direction of an arrow V) is formed.

The laser light having passed the one-dimensional spatial modulating unit 3 is irradiated on the recording surface of the disc 8 by the Fourier transforming lens 4. On the recording surface of the disc 8, as shown in FIG. 2, the Fourier image F having one 0th (zeroth)-order diffracted light L0 and two 1st-order diffracted lights L1 is formed. In the example of FIG. 2, since the grating configuration 3a of the one-dimensional spatial modulating unit 3 is formed in the V-direction in FIG. 2, those two 1st-order diffracted lights L1 are formed in line in the V-direction on both sides (the upper and lower sides) of the 0th-order diffracted light L0. It is noted that a distance between the 0th-order diffracted light L0 and the 1st-order diffracted light L1 on the disc 8 is determined by a distance between the gratings of the grating configuration 3a of the one-dimensional spatial modulating unit 3 and the wavelength of the light. The Fourier image F is recorded on the disc 8 as the interference fringes.

In the present invention, the Fourier image F is recorded on the recording medium, with the recording medium being moved relatively to the recording optical system. In the embodiment, since the recording medium is a disc, the Fourier image F which is formed on the recording surface of the disc 8 by the rotation of the disc 8 moves toward a tangent direction of the disc 8.

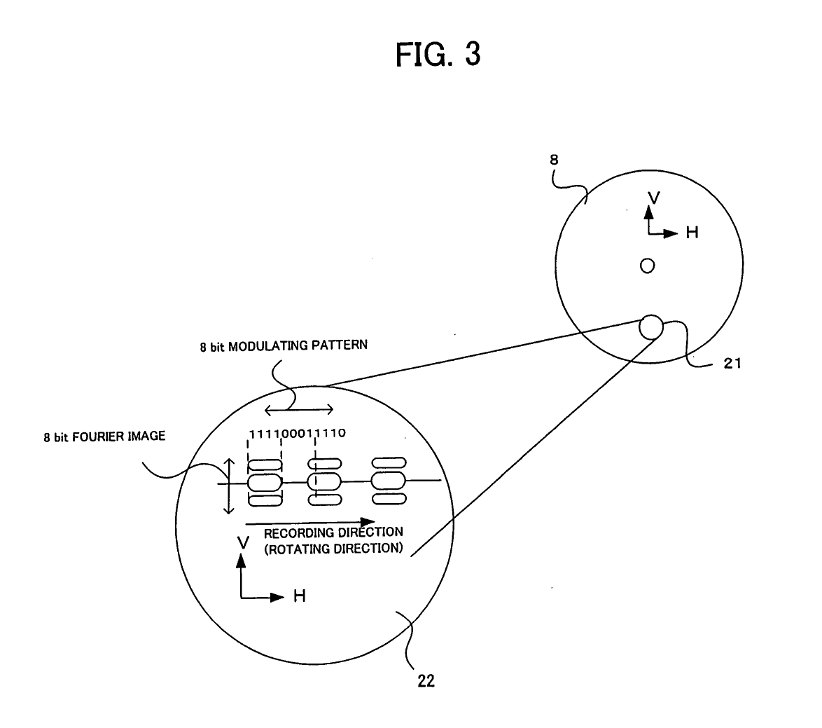

FIG. 3 schematically shows an example of the Fourier image F formed on the disc. It is noted that the example in FIG. 3 is an example in a case that the 8-bit one-dimensional spatial modulating unit 3 shown in FIG. 2 is utilized. On the disc 8, a portion 21 to which the recording light is irradiated is shown in a circle 22 as a magnified view.

In a state that disc 8 is stationary, the Fourier image F shown in FIG. 2 is recorded on the disc 8. However, since the disc moves relatively to the recording light, the Fourier image F which is actually recorded has elongated shape which is stretched out in the recording direction (in the tangent direction of the disc), as shown in FIG. 3. Hereafter, the Fourier image F which is recorded on the disc 8 is also called “hologram mark”.

The hologram mark shown in FIG. 3 is modulated in both of two directions, i.e., in the vertical direction (V-direction) and the horizontal direction (H-direction) in FIG. 3. It is noted that the V-direction shown in FIG. 3 is a radial direction of the disc 8, which corresponds to the V-direction shown in FIG. 2, i.e., the direction in which the gratings of the one-dimensional spatial modulating unit 3 are formed. The H-direction shown in FIG. 3 is the tangent direction of the disc 8.

One of the modulations in two directions is the modulation by the grating configuration 3a of the one-dimensional spatial modulating unit 3. In the embodiment, as shown in FIG. 2, the 8-bit one-dimensional spatial modulating unit 3 is utilized, and the Fourier image F recorded on the disc 8, i.e., the hologram mark, has 8-bit information in the V-direction.

Additionally, in the embodiment, the presence and the absence of the laser light irradiated (i.e., ON/OFF switching of the laser light source 1) is controlled in the recording direction, i.e., the H-direction in FIG. 3, and thereby the modulation is executed by a hologram mark length. It is noted that a light quantity may be controlled between two certain values, instead of ON/OFF switching of the laser light. In FIG. 3, a recording information example by the modulation of the mark length is indicated by numerical values “1” and “0”. In the example in FIG. 3, the hologram mark is formed during an ON period of the laser light source 1, and the period corresponds to the recording information “1”. On the other hand, during an OFF period of the laser light source 1, no hologram mark is formed, and the period corresponds to the recording information “0”.

In the example in FIG. 3, the 8-bit information is recorded in the V-direction by the one-dimensional spatial modulating unit 3, and the modulation by the mark length of the hologram mark is performed in the H-direction by the ON/OFF switching control of the laser light source, too. Like this, in the embodiment, since two kinds of the modulations, i.e., the modulations by the one-dimensional spatial modulating unit and by the ON/OFF switching of the laser light source, are combined, larger amount of information can be recorded.

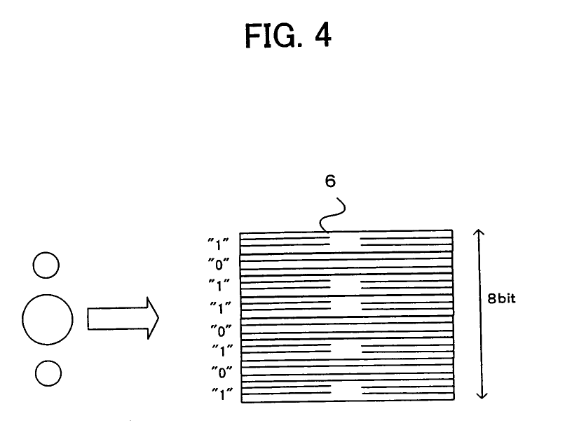

FIG. 4 shows a configuration example of the light-receiving element 6. In reproduction, only the reference light Lr is irradiated on the disc 8, and the diffracted light generated by the recorded Fourier image is inverse-Fourier-transformed by the inverse Fourier transforming lens 5 to be incident on the light-receiving element 6. The example shown in FIG. 4 is the 8-bit light-receiving element, and FIG. 4 indicates a state that the diffracted light corresponding to the 8-bit data “10110101” from the upper row is received.

[Modification]

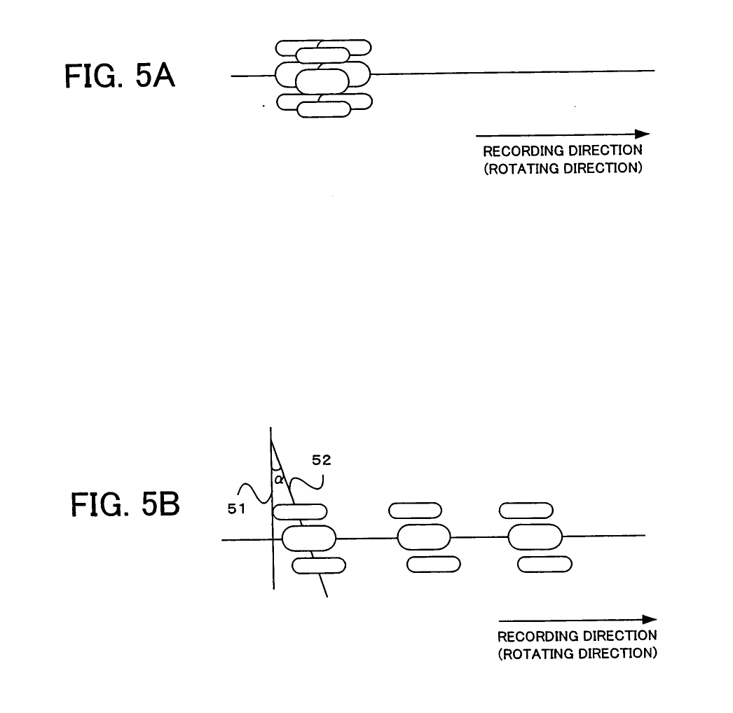

Since the hologram recording is performed in the present invention, different information can be recorded in a multiplexed manner (hereinafter referred to as “multi-recording”) at the identical position on the recording medium by varying recording conditions. For example, FIG. 5A schematically shows an example of the hologram mark in a case that the recording is performed by shifting a center of the 0th-order light of the Fourier image in the V-direction or the H-direction. Further, by varying an irradiating angle of the signal light or the reference light, the different information can be recorded in a multiplexed manner at the identical position on the recording medium, too. Moreover, if the property of the signal light is varied by the modulation of a spatial modulating unit, multi-recording can be performed, too. Generally, a multi-recordable quantity at the identical position on the hologram disc is indicated by M number, and the multi-recording of the information is possible within the range. For example, to the hologram disc whose M number is equal to 16, 16 different pieces of information can be recorded at the identical area.

In the above-mentioned embodiment, an axial direction of the Fourier image (i.e., a direction of a straight line formed by the 0th-order and 1st-order lights) is prescribed to have 90 degree to the rotating direction of the disc (i.e., 0 degree to the V-direction which is the radial direction of the disc). However, the recording can be performed with shifting the axial direction of the Fourier image from the radial direction of the disc, too. FIG. 5B shows an example thereof, in which the axial direction 52 of the Fourier image is shifted by an angle α with respect to the radial direction 51 of the disc.

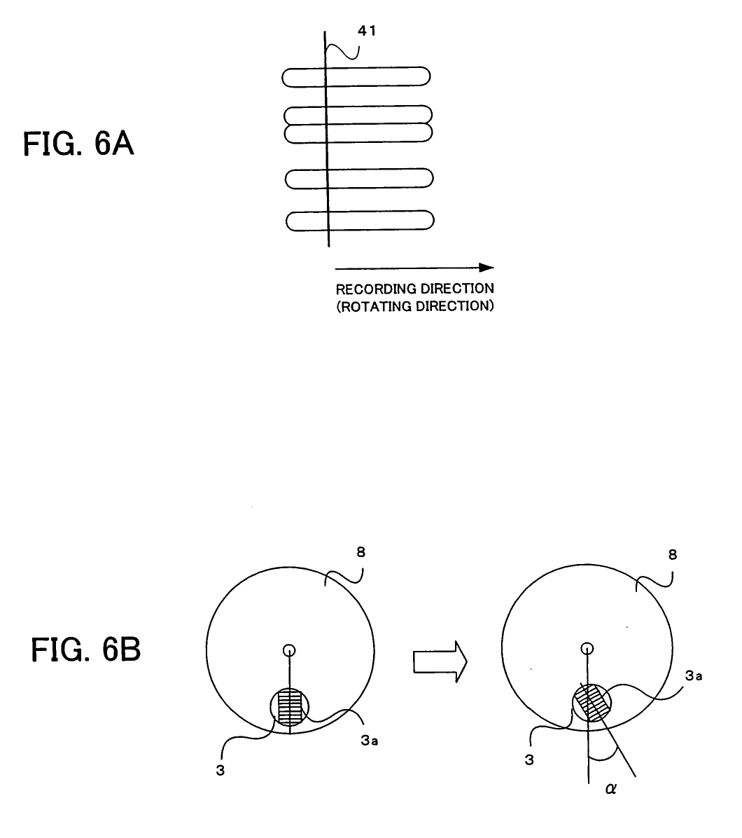

In a case of the disc-type recording medium, damage such as a scratch by a user handling a disc is made relatively often in the radial direction of the disc. FIG. 6A schematically shows a state thereof. Therefore, as shown in FIG. 6A, when a scratch 41 is made in the radial direction of the disc, no hologram mark in the identical radial direction is readable, and information in the portion cannot be reproduced at all. On the other hand, as shown in FIG. 5B, if the Fourier image is formed in the direction which is shifted with respect to the radial direction of the disc by a predetermined angle α, not all portions corresponding to an identical time base become unreadable, even though the scratch is made in the radial direction of the disc. Thus, there is high possibility that the data corresponding to the portion of the scratch can be restored by a method such as an error correction or the like. Therefore, by shifting the axial direction of the Fourier image, the recording which is hardly affected by the scratch in the radial direction of the disc is possible. In order to record information with rotating the axial direction of the Fourier image, as shown in FIG. 6B, the direction of the grating configuration 3a of the one-dimensional spatial modulating unit 3 may be rotated with respect to the radial direction of the disc by the angle α. It is noted that FIG. 6B is a top view schematically showing a relative positional relation between the disc and the one-dimensional spatial modulating unit 3.

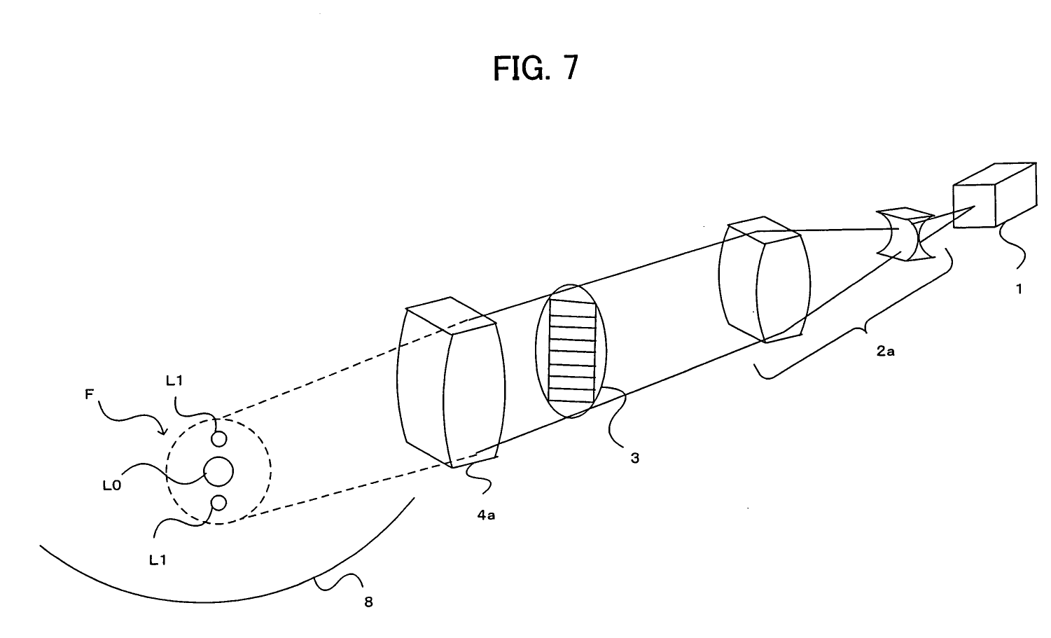

A cylindrical lens may be utilized for the expander 2 and the Fourier transforming lens 4. FIG. 7 shows a configuration of the optical system in that case.

Though the example in which the one-dimensional spatial modulating unit is utilized is described in the above embodiment, a two-dimensional spatial modulating unit may also be utilized. However, in that case, it is a necessary condition that reproducing data is not mixed in the moving direction of the recording medium during reproducing, even when the recording medium moves relatively to the recording light. For example, the two-dimensional spatial modulating unit, which has the identical values in the direction corresponding to the moving direction of the recording medium, may be applied.

The recording and reproducing apparatus shown in FIG. 1 is a so-called transmission-type recording and reproducing apparatus, which detects a reproducing light on an opposite side of the disc during reproducing. However, the present invention may be applied to a so-called reflection-type recording and reproducing apparatus, which executes the irradiation of the recording light and the detection of the reproducing light on one side of the disc, too.

The recording and reproducing apparatus shown in FIG. 1 includes the optical system which irradiates the signal light and the reference light generated by separating the laser light at the identical position on the recording medium from different directions. However, the present invention may be applied to a recording and reproducing apparatus which irradiates the signal light and the reference light on an identical axis, too.

As explained above, in the embodiment and the modification, by spatial-modulating the Fourier image only in the direction different from the moving direction of the recording medium and executing the recording, the pattern of the reproducing light can be distinguished, even though the Fourier image is moved relatively to the recording medium. Therefore, since stopping the recording medium is unnecessary during recording and reproducing the information, the random access performance is improved. Also, by modulating the information in the moving direction of the recording medium by the mark length, recording capacity can be increased.

Though the hologram disc is used as the recording medium in the above embodiment, the application of the present invention is not limited to a disc-type recording medium. For example, the present invention can be applied to various shapes of the recording mediums, such as a card-type recording medium.

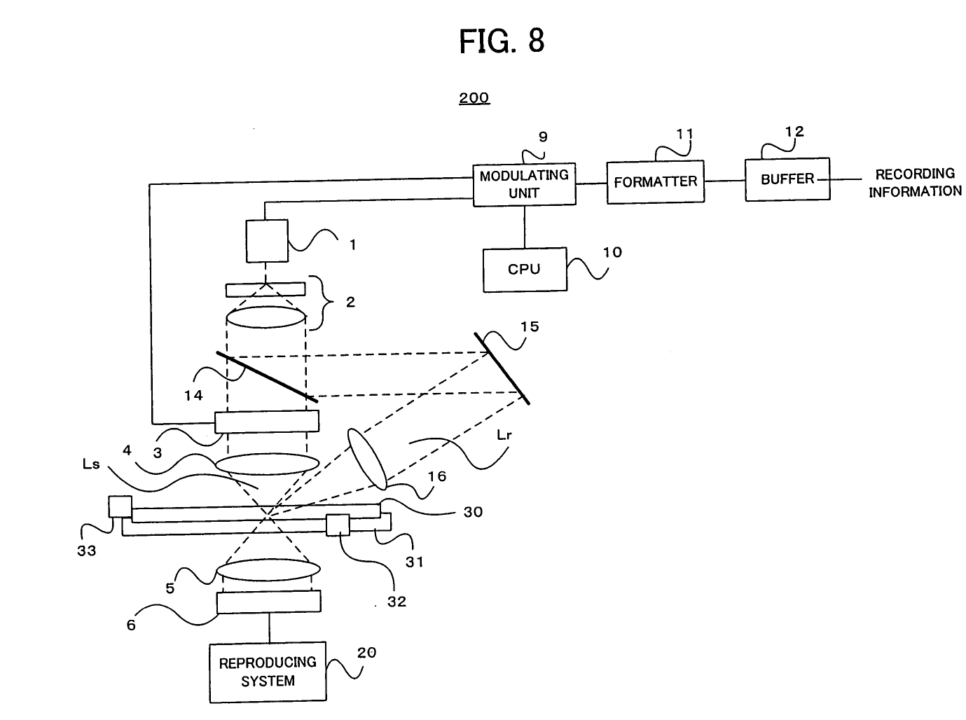

FIG. 8 schematically shows an example of the recording and reproducing to the card-type recording medium. In FIG. 8, a basic configuration of the recording and reproducing apparatus is identical to the configuration in the case of the disc-type recording medium shown in FIG. 1. However, the recording and reproducing apparatus in FIG. 8 is different from the recording and reproducing apparatus in FIG. 1, in that the recording and reproducing apparatus in FIG. 8 includes a card-type recording medium 30 and a mechanism for holding and moving it, instead of the mechanism for holding the disc 8 and rotating it.

Concretely, as shown in FIG. 8, the card-type recording medium 30 is disposed on a holder 31. The holder 31 includes an X-direction motor 32 which moves the card-type recording medium 30 in an X-direction (a right and left direction in FIG. 8), and a Y-direction motor 33 which moves the card-type recording medium 30 in a Y-direction (a vertical direction to the page of FIG. 8). While the card-type recording medium 30 is moved in the X-direction or Y-direction by driving the X-direction motor 32 and the Y-direction motor 33, the information recording and reproducing is performed.

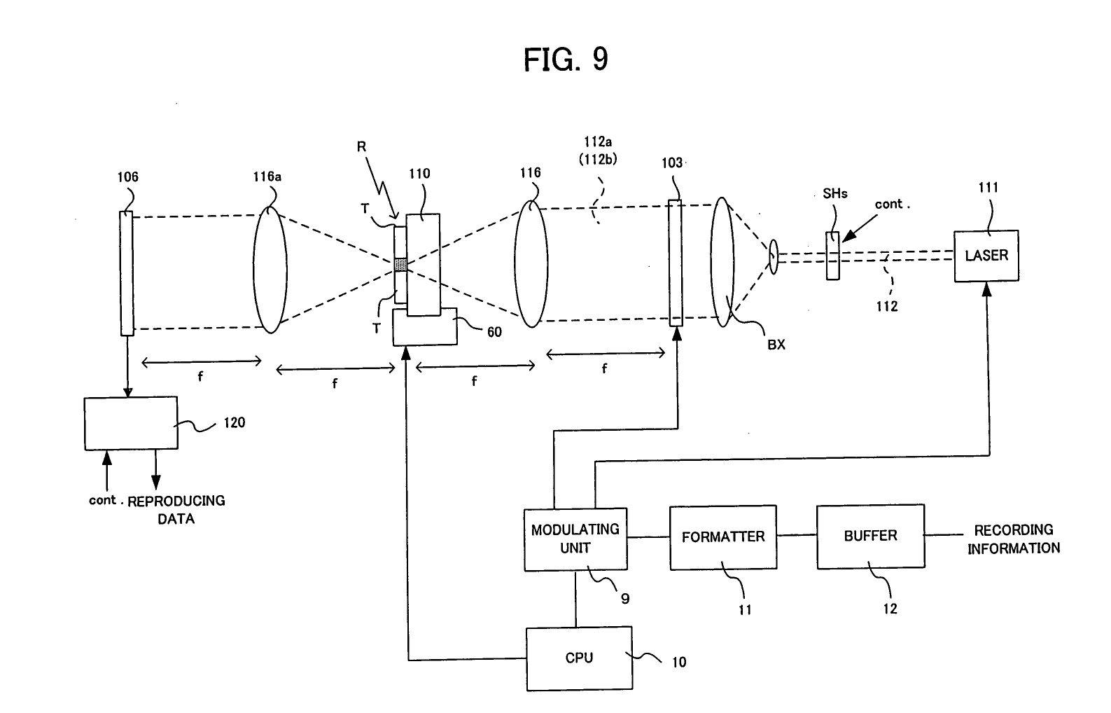

In the above embodiment, the signal light and the reference light are generated by dividing the optical light from the laser light source. However, the present invention can also be applied to the case in which the 0th-order light and a higher-order light interfere with each other, by utilizing the phenomenon that the 0th-order light having luminance component and the higher-order light having phase component are generated by making the laser light pass through the spatial modulating unit, without dividing the laser light. FIG. 9 shows a configuration example of a recording and reproducing apparatus in that case. In the example, by making the laser light be incident on the spatial modulating unit without dividing it, the interference fringes are generated by the interference between the 0th-order light and the higher-order lights of the incident light.

In FIG. 9, a shutter SHs, a beam expander BX, a one-dimensional spatial modulating unit 103, and a Fourier transforming lens 116 are disposed on a light path of an optical beam 112 from a laser light source 111. The laser light source 111, the beam expander BX, the one-dimensional spatial modulating unit 103 and the Fourier transforming lens 116 can be formed basically identically to each corresponding element in the embodiment shown in FIG. 1. The shutter SHs, which is controlled by a controller not shown, controls an irradiation time period of the light beam to the recording medium.

On the other hand, a recording medium 110 is held in a movable manner by a movable stage 60; The movable stage 60, which is controlled by the controller not shown, moves the recording medium 110 to a predetermined direction during the information recording and reproducing.

The beam expander BX enlarges the diameter of the light beam 112 having passed the shutter SHs to form a parallel beam, and makes the parallel beam be incident on the one-dimensional spatial modulating unit 103. Identically to the embodiment in FIG. 1, the recording information is transmitted to the modulating unit 9 via the buffer 12 and formatter 11. The modulating unit 9, which is controlled by a CPU 10, modulates the laser light emitted from the laser light source 111 and the signal beam emitted from the one-dimensional spatial modulating unit 103. The signal beam 112a having passed the one-dimensional spatial modulating unit 103 is irradiated to the recording medium 110 by the Fourier transforming lens 116.

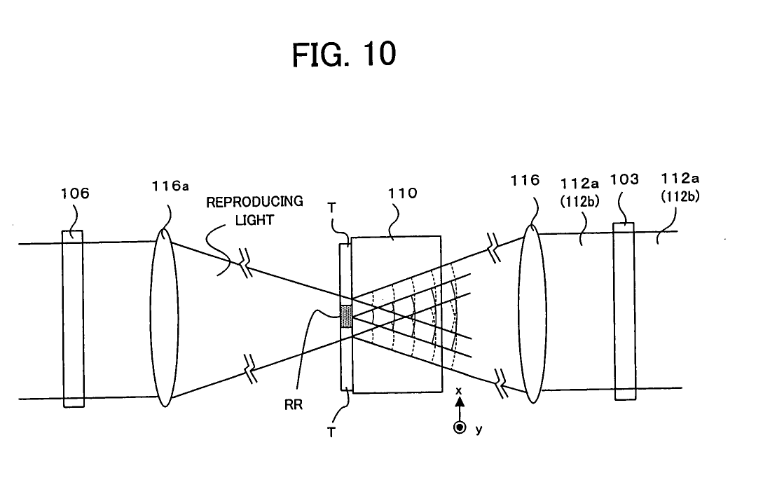

FIG. 10 shows a state of the light beam in the vicinity of the recording medium 110. On the recording medium 110, an incident light processing portion R is provided on a surface of a side opposite to an incident side of the signal light 112a. The incident light processing portion R has a function to separate the 0th-order light and the higher-order light of the incident light on the recording medium 110, and returns a portion of the light to the recording medium 110. Concretely, the incident light processing portion R includes a 0th-order light reflection portion RR which reflects only the 0th-order light of the signal light 112a to the inside of the recording medium 110, and a portion T which prescribes the range of the portion RR. The 0th-order light reflection portion RR reflects the 0th-order light of the signal light 112a to the inside of the recording medium 110. The interference fringes are formed by the 0th-order light reflected to the inside of the recording medium 110 by the 0th-order light reflection portion RR and the higher-order light, and is recorded inside the recording medium 110. According to the principle, it is unnecessary that the light beam from the laser light source is divided to form the reference light, like the embodiment shown in FIG. 1.

During reproducing, as shown in FIG. 10, only the reference light 112b is irradiated. Similarly to the recording, the reference light 112b which has passed the recording medium 110 is vertically incident on the recording medium 110. If the reference light 112b passes the recording medium 110, the reproducing light which reproduces the recorded interference fringes is obtained on the opposite side of the recording medium 110 to which the reference light 112 is irradiated. The reproducing light is inverse-Fourier-transformed by an inverse Fourier transforming lens 116a and is guided to a light-receiving element 106. An electric signal corresponding to the reproducing light is supplied from the light-receiving element 106 to a reproducing system 120, and reproducing data is outputted from the reproducing system 120.

The above embodiment is explained by ±1st-order lights. However, since +1st-order light and −1st-order light have an identical property, the identical effect can be obtained by only one of +1st-order light and −1st-order light.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2003-106278 filed on Apr. 10, 2003 including the specification, claims, drawings and summary is incorporated herein by reference in its entirety.

What is claimed is:

1. An information recording apparatus comprising:
a laser light source;
a dividing unit which divides a laser light emitted from the laser light source in two laser lights;
a one-dimensional spatial modulating unit which applies one-dimensional spatial modulation to one of the two divided laser lights based on recording information;
a recording optical system which irradiates the spatial-modulated laser light to a recording medium as a signal light and irradiates the other one of the two divided laser lights to the recording medium as a reference light, thereby to record the recording information on the recording medium; and
a moving unit which moves the recording medium with respect to the recording optical system such that an irradiation position of the signal light and the reference light relatively moves on the recording medium, wherein the recording optical system records the recording information while the moving unit is moving the recording medium.

2. The information recording apparatus according to claim 1, wherein the one-dimensional spatial modulating unit comprises a grating configuration having a plurality of gratings, and wherein the one-dimensional spatial modulating unit is positioned such that an alignment direction of irradiation images produced by the plurality of gratings is perpendicular to the moving direction of the recording medium by the moving unit.

3. The information recording apparatus according to claim 2, wherein the recording medium is a disc, wherein the moving unit rotates the disc, and wherein the one-dimensional spatial modulating unit is positioned such that the alignment direction of the irradiation images produced by the plurality of gratings corresponds to a radial direction of the disc.

4. The information recording apparatus according to claim 1, wherein the one-dimensional spatial modulating unit comprises a grating configuration having a plurality of gratings, and wherein the one-dimensional spatial modulating unit is positioned such that an alignment direction of irradiation images produced by the plurality of gratings has a predetermined angle with respect to a direction perpendicular to the moving direction of the recording medium by the moving unit.

5. The information recording apparatus according to claim 4, wherein the recording medium is the disc, wherein the moving unit rotates the disc, and wherein the one-dimensional spatial modulating unit is positioned such that the alignment direction of the irradiation images produced by the plurality of gratings has a predetermined angle with respect to the radial direction of the disc.

6. The information recording apparatus according to claim 1, further comprising a unit which controls a light quantity of the laser light from the laser light source based on the recording information.

7. An information reproducing apparatus comprising:
a laser light source;
a reproducing unit which irradiates a laser light emitted from the laser light source to a recording medium as a reference light, and which reproduces recording information recorded on the recording medium based on the laser light transmitted through or reflected by the recording medium; and
a moving unit which moves the recording medium with respect to a recording optical system such that an irradiation position of the reference light relatively moves on the recording medium, wherein the reproducing unit reproduces the recording information while the moving unit is moving the recording medium.

8. An information recording method comprising:
a dividing process which divides a laser light emitted from a laser light source in two laser lights;
a modulating process which applies one-dimensional spatial modulation to one of the two divided laser lights based on recording information;
a recording process which irradiates the spatial-modulated laser light to a recording medium as a signal light and irradiates the other one of the two divided laser lights to the recording medium as a reference light, thereby to record the recording information on the recording medium; and
a moving process which moves the recording medium with respect to a recording optical system such that an irradiation position of the signal light and the reference light relatively moves on the recording medium, and wherein the recording process is executed while the recording medium is being moved by the moving process.

9. An information reproducing method comprising:
a reproducing process which irradiates a laser light emitted from a laser light source to a recording medium as a reference light, and which reproduces recording information recorded on the recording medium based on the laser light transmitted through or reflected by the recording medium; and
a moving process which moves the recording medium with respect to a recording optical system such that an irradiation position of the reference light relatively moves on the recording medium, wherein the reproducing process is executed during the recording medium is being moved by the moving process.

10. An information recording medium on which the recording information is recorded by the information recording apparatus according to claim 1.

11. An information recording apparatus comprising:
a laser light source;
a one-dimensional spatial modulating unit which applies one-dimensional spatial modulation to a laser light emitted from the laser light source based on recording information;
a recording optical system which irradiates a light mainly including luminance component of the spatial-modulated laser light to a recording medium as a reference light and irradiates alight mainly including phase component of the spatial-modulated laser light to the recording medium as a signal light, thereby to record the recording information on the recording medium; and
a moving unit which moves the recording medium with respect to the recording optical system such that an irradiation position of the signal light and the reference light relatively moves on the recording medium, wherein the recording optical system records the recording information while the moving unit is moving the recording medium.

12. The information recording apparatus according to claim 11, wherein the one-dimensional spatial modulating unit comprises a grating configuration having a plurality of gratings, and wherein the one-dimensional spatial modulating unit is positioned such that an alignment direction of irradiation images produced by the plurality of gratings is directed perpendicular to the moving direction of the recording medium by the moving unit.

13. The information recording apparatus according to claim 11, wherein the one-dimensional spatial modulating unit comprises a grating configuration having a plurality of gratings, and wherein the one-dimensional spatial modulating unit is positioned such that an alignment direction of the irradiation images produced by the plurality of gratings has a predetermined angle with respect to a direction perpendicular to the moving direction of the recording medium by the moving unit.

14. The information recording apparatus according to claim 11, further comprising a unit which controls a light quantity of the laser light from the laser light source based on the recording information.

15. An information recording method comprising:
a modulating process which applies one-dimensional spatial modulation to a laser light emitted from a laser light source based on recording information;
a recording process which irradiates a light mainly including luminance component of the spatial-modulated laser light to a recording medium as a reference light and irradiates a light mainly including phase component of the spatial-modulated laser light to the recording medium as a signal light, thereby to record the recording information on the recording medium; and
a moving process which moves the recording medium with respect to a recording optical system such that an irradiation position of the signal light and the reference light relatively moves on the recording medium, wherein the recording process is executed while the recording medium is being moved by the moving process.

16. An information recording medium on which the recording information is recorded by the information recording apparatus according to claim 11.
